(19) United States
(12) Patent Application Publication
(10) Pub. No.: US 2005/0055223 A1
(43) Pub. Date: Mar. 10, 2005

(54) Method and implementation for real time retail

(76) Inventor: Rajesh Khosla, Orange, OH (US)

Correspondence Address: John X. Garred;Tucker Ellis & West LLP, Ste. 1150, 925 Euclid Ave., Cleveland, OH, 44115, US

(21) Appl. No.: 10/654,843

(22) Filed: Sep. 4, 2003

(51) Int. Cl. G06F 17/60

(52) U.S. Cl. 705/1

(57) ABSTRACT

A method and implementation of retail management is presently disclosed. An arrangement is provided in which information is obtained on one or more status indicators of a retail sales establishment. An arrangement is provided for dispatching a message to sales personnel of the retail sales establishment in connection with the status indicator, so as to solicit a response following the status indicator.

### BACKGROUND OF THE INVENTION

Retail sales establishments have historically included a store having merchandise items for sale along with one or more sales personnel to assist customers with finding desired items and completing sales transactions. It is well understood that customers make purchasing decisions based on interest level in a particular merchandise item. This can be influenced by the organization and presentation of the merchandise. For example, a battery-powered display item should be operating in order to properly demonstrate its function, so as to interest a customer. And having attracted the customer's attention, the customer's interest can be further cultivated by timely and helpful information provided by sales personnel.

However, it is also understood that inadequate presentation of the merchandise can have a negative influence on a customer's interest level, and as such can adversely affect the total sales of the retail establishment. For example, if a battery-powered display item runs out of power, it is less effective at capturing the interest of a customer. Also, if a customer is potentially interested in an item, but does not receive timely and helpful assistance from sales personnel, the customer may leave the store without purchasing the item. Other factors may also have a negative impact on customer interest, such as disorder among merchandise items, or a depletion of merchandise from a particular shelf. Also, spills and messes or other such factors may occur within the retail establishment and be obscured from direct line of sight, or otherwise may not be immediately noticed by sales personnel.

### SUMMARY OF THE INVENTION

The difficulties and drawbacks of previous-type approaches are overcome by the presently disclosed method and implementation of retail management. An arrangement is provided in which information is obtained on one or more status indicators of a retail sales establishment. An arrangement is provided for dispatching a message to sales personnel of the retail sales establishment in connection with the status indicator. A response follows the status indicator. Further details of various embodiments of the present method and apparatus follow herewith.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 generally indicates a retail establishment outfitted with a network in accordance with the present invention.

FIG. 2 is a flow chart depicting the network interactivity between various components within the network in accordance with the present invention.

FIG. 3 is an overhead view depicting the positional tracking of a customer and a sales personnel through a retail establishment in accordance with the present invention.

FIG. 4 shows a monitor visual interface showing sales data superimposed on a visual view of the retail establishment.

### DETAILED DESCRIPTION OF THE INVENTION

Specific reference will now be made to the drawing figures where like reference numerals in the figures are understood to correspond to like elements. The continued enhancement of a variety of technologies, as implemented in a retail environment, enables real-time improvement of retail floor operations in a cost effective fashion. These enhancements would provide the ability to provide better retail presentation, improved customer service and superior monitoring, resulting in a better experience for the shopper and higher retail sales for the retailer.

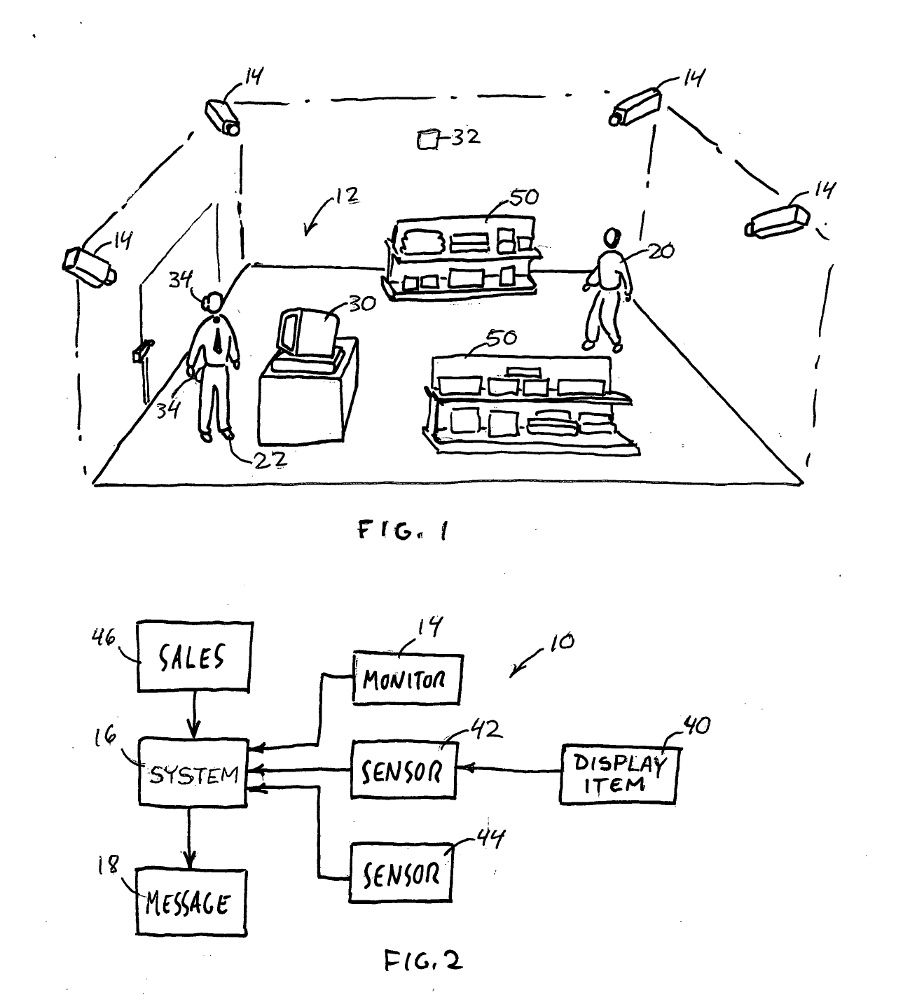

As shown especially in FIGS. 1 and 2, a retail management network 10 and related method includes an implementation for obtaining information on one or more status indicators of a retail sales establishment 12. In one embodiment, this implementation for obtaining information can be one or more visual monitors 14 for one or more locations in the retail establishment. These visual monitors 14 are preferably video cameras that return an image of an area of the retail establishment 12. Of course, it should be understood that any type of photodetector, or an imaging or non-imaging component, or other such device could be used without departing from the invention. The visual monitors 14 are preferably part of a control system 16 for monitoring a plurality of locations in the retail establishment. The control system 16 may be included in a personal computer, or may be implemented through a peripheral computer component that can be connected to a remote location using a wide area network or an other network such as the Internet. The visual monitors 14 may be able to observe one or more potential customers 20 at the same time, and in this way, the positions of the customers and sales personnel 22 can be triangulated using a suitable processing mechanism. In this way, it is possible to correlate positions of the potential customer 20 and also the sales personnel 22.

In this instance, the aforementioned “status indicator” can be characterized by a time interval in which the potential customer has been in the retail establishment, or alternatively the time interval in which the potential customer 20 has lingered at a particular merchandise display without being approached by sales personnel 22. A message implementation 18 for dispatching a message can be used to send notification to the sales personnel 22 in connection with the status indicator. In this instance, the sales personnel 22 may be in the supply room or otherwise preoccupied, and thereby be notified of the potential customer 20. In this way, the message implementation 18 enables the sales personnel 22 to respond to the status indicator.

It should be understood that in one embodiment, the message implementation 18 can be manually activated by supervisory personnel. Such supervisory personnel can be located on-site or in a remote location where a number of affiliated retail establishments can be simultaneously monitored. In an alternative embodiment, the message implementation can be an integrated function automatically performed by the control system 16. In this way, the supervisory function is automated, thereby reducing costs by eliminating a salary position.

The message implementation 18 can be selected to dispatch any sort of message, preferably audio, visual or both. For example, the message implementation can be an audio attention device, actuable to produce an audio attention signal. The audio attention signal can be an attention tone, in which a specific tone is used to signal the sales personnel to a specific corresponding message. Also, an attention code can be used including some recognizable sequence of tones, correlated to communicate a specific message. In the preferred embodiment, the audio attention device can be used to communicate a verbal message. The audio attention device can be an integrated function of a personal computer 30, in which an audible message is delivered through a messaging system. The audio attention device can also be a wall-mounted device 32. It can also be a wireless device 34 worn by the sales personnel 22, such as an earphone, a pager, a cellular phone, or a personal digital assistant.

Alternatively or additionally, the message implementation 18 can be a visual attention device actuable to produce a visual attention signal. The visual attention device can be an alphanumeric message display, or an indicator for displaying a message code, such as a color; a configuration, or a timed sequence of indicia. The visual attention device can also be an integrated function of the personal computer 30, in which an visual message is delivered through a messaging system. The visual attention device can also be a incorporated into the wall-mounted device 32. It can also be incorporated into a wireless device 34 worn by the sales personnel 22, such as a pager, a cellular phone display, or a personal digital assistant.

As generally indicated in FIG. 2, the implementation for obtaining information can include other types of sensors configured in such a way that the “status indicator” can be characterized by the detection of other predetermined conditions. For example, suppose there is a display item 40 that must be functioning in order to properly demonstrate the product. The display item 40 may run out of battery power, become unplugged from utility-supplied power, or otherwise malfunction. In this instance, the associated product will likely lose sales until the fault condition is corrected. However, the fault condition may be unnoticed by sales personnel 22 for a period of time. Thus, a sensor 42 may be configured to detect a fault condition a power-operated merchandise display item. The sensor 42 is interfaced through the network to the message implementation 18 to dispatch a message to alert sales personnel 22 to the fault condition, so as to restore power or replace the display item 40.

Other types of sensors 44 can be used to detect various other status indicators. For example, a sensor 44 can be configured to detect the entry of a potential customer 20 into the retail establishment. This sensor 44 can be a touch-actuated sensor integrated into a floor mat to detect the footsteps of a potential customer. Alternatively, the sensor 44 can be a visual sensor configured to detect a visual property of a garment of the potential customer, e.g. a garment color. The visual sensor can be a discrete sensor or an integrated function of the video cameras 14. In any case, the sensor can detect the entry of a potential customer into the retail establishment, and can provide a reference point for tracking the customer through the store. This would be especially convenient when the store is crowded with several potential customers. Such customer tracking could also be used to detect thefts while still in progress, thereby improving security. In any case, the sensors 42, 44 would preferably report back to the control system 16, which would then actuate the message implementation 18 to alert the sales personnel 22.

The visual monitors 14 can also be used to provide other status indicators as to the condition of the retail establishment. For example, one or more visual monitors 14 can be configured to monitor a particular shelf of merchandise items and/or a surrounding merchandise area, to determine a sub-optimal display condition. The message implementation 18 can dispatch an alert component for alerting sales personnel to the sub-optimal display condition, so as to enable correction. The sub-optimal condition can include disorder on the shelf area among merchandise items or depletion of merchandise from a particular shelf. The system can also detect and notify if spills and messes occur in a display area, and allow real-time correction of the problems.

Additional components can be incorporated to cooperate with the visual monitors 14. The wireless device 34 worn by the sales personnel 22 can also include a wireless transponder for communicating the position of the sales personnel to monitor system. This transponder can communicate position directly to the control system 16, or can include an externally-referenced position system, such as a GPS component installed into a pager, cellular phone or personal digital assistant. This information can be used in the correlation of the position of sales personnel 22 with respect to the potential customers 20.

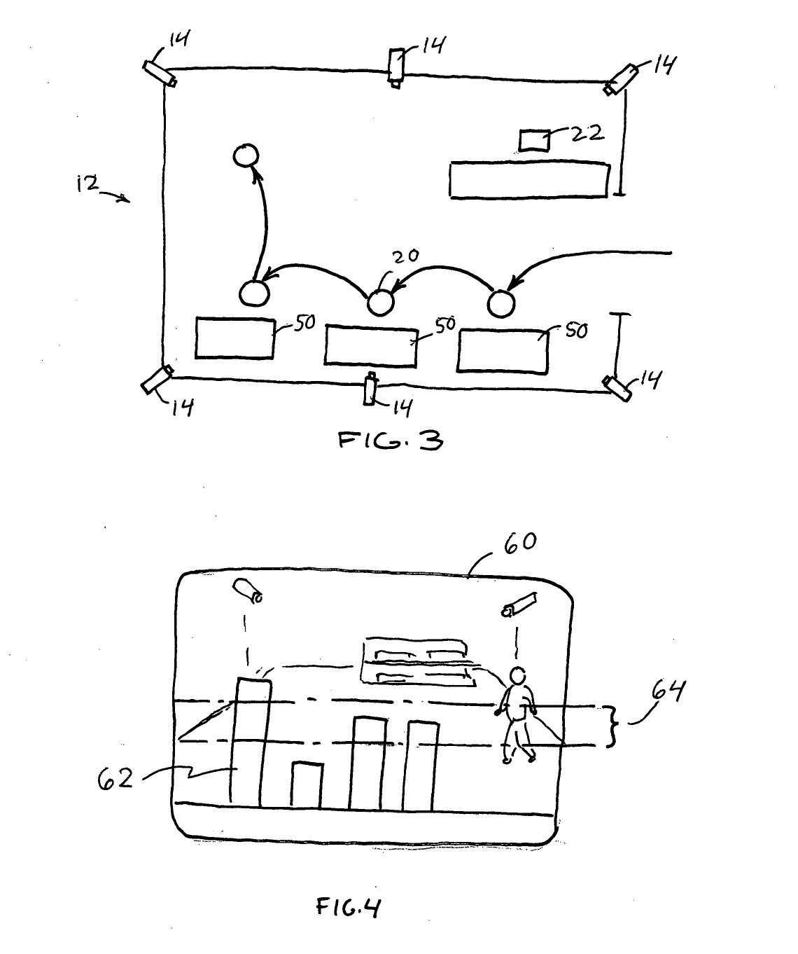

As another special feature, as shown in FIG. 3, the present control system 16 can be configured to process and collect the triangulated positions of a potential customer 20 as recorded by the visual monitors 14. In this way, the control system 16 can track the path of the customer 20 through the retail establishment 12. As indicated above, as the customer's path is tracked, the time a customer spends looking at a particular merchandise display 50 may be recorded. This status indicator information may be correlated with the customer's purchases and recorded by the control system 16. The control system 16 may further include an implementation for compiling statistical data of the positions of a number of potential customers, and correlate with their purchases. In this way, it may be determined which merchandise displays 50 are the best placed and most attractive, therefore the most profitable. This information can be used in further market research and display planning, so as to optimize the effectiveness of the retail floor plan. This approach can similarly be used to track the positions of the sales personnel 22, and correlate with the resulting sales transactions. In this way, it is possible to compile information that can be analyzed to observe patterns in the responsiveness of sales personnel to customers, and correlate these patterns with cash register receipts to determine profitability.

As indicated above, the cash register activity can be monitored to compile sales information. As indicated in FIG. 2, a monitoring implementation 46 can be further provided for monitoring sales to generate one or more sales indicators of the retail sales establishment. The monitoring implementation 46 is interfaced with a cash register system equipped to indicate the types and numbers of merchandise items sold within a predetermined period. The monitoring implementation 46 can thus be configured to track sales indicators for various merchandise items. As shown in FIG. 4, a computer monitor 60 may be retained in a remote location viewing the scene in the store from a selected visual monitor 14. Sales indicators 62 for one or more items can be displayed on the computer monitor as a series of bar graphs or other such visual indicia, superimposed over the scene in the store. The present control system 16 receives the sales information and includes a correlation implementation for correlating the output from the monitoring implementation 46 with the status indicators. The sales indicators 62 can thus be quantified and compared with statistical data representative of the expected sales for particular item. A range 64 of expected sales can be displayed on the computer monitor 60 so as to determine whether the sales indicators 62 for each item meet expectations. If the expectations are not met, the message implementation can dispatch a message instructing sales personnel to focus more attention on selling a particular type of merchandise item, so as to improve the sales indicator for that item.

The present invention will now be further described with an example that illustrates various functions and capabilities of the present invention. A toy store chain has ten departments, featuring different categories of merchandise items, all of which, based upon historical performance or estimation, should provide a certain percentage of each store's sales. For instance, battery operated toys should provide 5% of sales, dolls should provide 10% of sales, board games should provide 7% of sales, one particular bubble gun should be 3% of sales, etc. The store's cash register has a connection (either hard-wired or wireless) enabling communication to the home office. The connection can either be a dedicated direct connection or implemented through the Internet to provide “real-time” or near-real time communication.

The cash register function can be incorporated into the personal computer 30 or other type standard computing device. It can also be a dedicated cash register designed or refitted to perform the necessary functions. The cash register is enabled to allow instant messaging with the home office, allowing for real-time or near-real-time communication with sales personnel 22. Alternatively, a wireless device (e.g. pager, cell phone, PDA, etc) can be worn to allow direct communications with sales personnel 22 on a real or near-real-time basis. In a particular embodiment, a wireless headset 34 can be worn by the sales personnel 22 that connects to the instant messaging function to provide the instant communications. Alternatively, an audio or visual cueing device, incorporated into the PC 30 or as a separate wall-mounted unit 32, could supplement or substitute for the instant messaging function.

In an embodiment where the status indicators include visual information, the visual monitor 14 can include one or more cameras mounted in the retail establishment for transmitting real-time or near-real time pictures of the retail environment back to a remote site. At the remote site, the control system 16 processes both the sales indicator data 46 from the cash register as well as the visual images transmitted by the visual monitors 14. The control system 16 compares the store sales by category or by item against the expected sales range. When the sales fall below the proper range, either an automated message or a human call can be placed through instant messaging, cellular or other instantaneous or near instantaneous communications mechanisms, either directly to the sales personnel 22 or to the cueing system informing them of this event and providing suggestions on how to rectify the situation.

For instance, in retail operations where demonstration of an item can make a significant sales difference (perfume sampling, for instance) the sales personnel make to instructed to “Please make sure the item is being properly sampled to the customers.” If the sales are above the range in a certain merchandise category, either an automated message or a supervisor can respond with a variety of responses including “Too much emphasis is being placed on this particular product category” or “Please inform us what you are doing to enhance sales of this category so that we may instantly inform the other retail stores.” The visual information provided by the visual monitors 14 can be used to monitor and enhance the store level performance by mentioning directly in the floor managers ear “Customers need assistance in the next aisle” or “Please fix the demonstration product in your aisle” or “Please get up off the chair and assist customers.”

The present invention also assists sales personnel. If a potential customer has a problem or asks a difficult question about a merchandise item, the sales personnel could contact the supervisory personnel directly through the headset or cell phone, send an instant message back through the PC or PDA, or even wave their hands or otherwise gesture at the visual monitors 14 to attract attention at the remote monitoring site. In this manner, two-way communications can be facilitated that can improve efficiency and allow rapid correction of problems that may arise in the retail environment.

The present method and apparatus offer many benefits, including highly efficient, real-time monitoring of store operations. This is a huge leap in efficiency over using district managers, mystery shoppers and other such techniques as are known in the industry. All those methods are comparatively very expensive and depend upon intermittent monitoring and testing of store level personnel. Feedback also travels through a longer and slower channel. The present invention allows the ability to fix problems in real-time. Under-performing store personnel or inefficient practices are quickly monitored, processed and result in instantaneous feedback. By improving two-way communication, the invention allows the ability to quickly disseminate improved sales practices in real-time. For instance, if one store finds a particularly inventive sales methodology that results in a boost of sales of a particular product or line, then that information is picked up by the system, querying of the store personnel quickly occurs and the resultant methodology can be transmitted instantaneously to other stores. This improved communication can be particularly advantageous during the 4^{th} quarter “holiday rush,” where real-time dissemination of information can provide a crucial method in improving sales performance.

The invention also allows the ability to monitor the retail environment and sales personnel for practices or situations that might result in litigation (i.e. spills or other situations potentially injurious to customers) and provide correction on a real-time basis. Further, the invention allows the ability to restock merchandise items based upon real time information rather than information that is batched on a less frequent basis. The present invention also allows the ability to monitor, track and respond to retail trends on a faster basis that that provided by methods that rely on batching information on a less frequent basis. Also, the invention allows the ability to reduce shrink by providing an additional “eye in the sky,” thereby freeing store personnel to concentrate on the stocking and sales processes. The present methodology will keep the stores operating at maximum efficiency, and reduce costs associated with training, monitoring and correctional costs, while providing a superior customer shopping experience.

As described hereinabove, the present invention solves may problems associated with previous type systems. However, it will be appreciated that various changes in the details, materials and arrangements of parts which have been herein described and illustrated in order to explain the nature of the invention may be made by those skilled in the area within the principle and scope of the invention will be expressed in the appended claims.

1. A method of retail management comprising the steps of:
obtaining information on at least one status indicator of a retail sales establishment;
dispatching a message to sales personnel of the retail sales establishment in connection with the at least one status indicator; and
responding to the at least one status indicator.

2. The method of claim 1 wherein the step of obtaining information on at least one status indicator comprises visually monitoring at least one location in the retail establishment.

3. The method of claim 2 wherein the step of visually monitoring comprises monitoring at least one of a potential customer and the sales personnel.

4. The method of claim 3 wherein the step of visually monitoring comprises monitoring a plurality of locations in the retail establishment so as to correlate positions of at least one of the potential customer and the sales personnel.

5. The method of claim 4 wherein the step of dispatching a message comprises altering the sales personnel to presence of the potential customer, wherein the step of responding comprises approaching the potential customer by the sales personnel.

6. The method of claim 4 wherein the step of visually monitoring further comprises compiling statistical data of the positions of at least one of the potential customer and the sales personnel.

7. The method of claim 2 wherein the step of visually monitoring comprises monitoring at least one of merchandise items and a surrounding merchandise area, to determine a sub-optimal display condition, wherein the step of dispatching a message comprises alerting sales personnel to the sub-optimal display condition, and the step of responding comprises correcting the sub-optimal condition.

8. The method of claim 7 wherein the sub-optimal condition is selected from a group comprising: disorder among merchandise items; depletion of merchandise; and spills and messes in a display area.

9. The method of claim 1 wherein the step of obtaining information on at least one status indicator comprises receiving data from a sensor configured to detect a predetermined condition.

10. The method of claim 9 wherein the sensor is configured to detect a fault condition in at least one power-operated merchandise display item, wherein the step of dispatching a message comprises alerting sales personnel to the fault condition, and wherein the step of responding correcting the fault condition.

11. The method of claim 9 wherein the sensor is configured to detect the entry of a potential customer into the retail establishment.

12. The method of claim 11 wherein the sensor is a visual sensor configured to detect a visual property of a garment of the potential customer.

13. The method of claim 1 wherein the step of dispatching a message comprises actuating an audio attention device selected from a group comprising: an attention tone; an attention code; and a verbal message.

14. The method of claim 1 wherein the step of dispatching a message comprises actuating a visual attention device selected from a group comprising: an alphanumeric message display; and an indicator for displaying at least one of a color; a configuration, and a timed sequence of indicia.

15. The method of claim 1 further comprising a step of monitoring at least one sales indicator of the retail sales establishment, and correlating the step of monitoring to the step of obtaining information on at least one status indicator of a retail sales establishment, so as to improve the sales indicator.

16. A retail management network comprising:
an implementation for obtaining information on at least one status indicator of a retail sales establishment;
an implementation for dispatching a message to sales personnel of the retail sales establishment in connection with the at least one status indicator, so as to enable sales personnel to respond to the at least one status indicator.

17. The network of claim 16 wherein the implementation for obtaining information on the at least one status indicator comprises at least one visual monitor for at least one location in the retail establishment.

18. The network of claim 17 wherein the at least one visual monitor is part of a control system for a plurality of locations in the retail establishment so as to correlate positions of at least one of the potential customer and the sales personnel.

19. The network of claim 18 wherein the control system includes a wireless transponder worn by the sales personnel, for communicating the position of the sales personnel to monitor system.

20. The network of claim 18 wherein the control system further comprises an implementation for compiling statistical data of the positions of the at least one of the potential customer and the sales personnel.

21. The network of claim 17 wherein the at least one visual monitor is configured to monitor at least one of merchandise items and a surrounding merchandise area, to determine a sub-optimal display condition, wherein the implementation for dispatching a message comprises an alert component for alerting sales personnel to the sub-optimal display condition, so as to enable correcting the sub-optimal condition.

22. The network of claim 21 wherein the sub-optimal condition is selected from a group comprising: disorder among merchandise items; depletion of merchandise; and spills and messes in a display area.

23. The network of claim 16 wherein the implementation for obtaining information on at least one status indicator comprises a sensor configured to detect a predetermined condition.

24. The network of claim 23 wherein the sensor is configured to detect a fault condition in at least one power-operated merchandise display item, and wherein the sensor interfaces with the implementation for dispatching a message to alert sales personnel to the fault condition.

25. The network of claim 23 wherein the sensor is configured to detect the entry of a potential customer into the retail establishment.

26. The network of claim 25 wherein the sensor is a visual sensor configured to detect a visual property of a garment of the potential customer.

27. The network of claim 16 wherein the implementation for dispatching a message comprises an audio attention device, actuable to produce an audio attention signal selected from a group comprising: an attention tone; an attention code; and a verbal message.

28. The network of claim 16 wherein the implementation for dispatching a message comprises a visual attention device actuable to produce a visual attention signal selected from a group comprising: an alphanumeric message display; and an indicator for displaying at least one of a color; a configuration, and a timed sequence of indicia.

29. The network of claim 16 wherein the implementation for dispatching a message comprises a wireless device worn by the sales personnel, selected from a group comprising: an earphone; a pager; a cellular phone; and a personal digital assistant.

30. The network of claim 16 further comprising a monitoring system including a monitoring implementation for monitoring at least one sales indicator of the retail sales establishment, and a correlation implementation for correlating an output from the monitoring implementation with an output of the implementation for obtaining information on at least one status indicator of a retail sales establishment, so as to improve the sales indicator.

31. The network of claim 30 wherein the monitoring implementation is interfaced with a cash register system that indicates types and numbers of merchandise items sold within a predetermined period.
